(19) United States
(12) Patent Application Publication
(10) Pub. No.: US 2014/0267212 A1
(43) Pub. Date: Sep. 18, 2014

(54) DISPLAY PANEL AND METHOD OF DISPLAYING IMAGES

(71) Applicant: AU Optronics Corp, Hsin-Chu (TW)

(72) Inventors: Jian-Feng Li, Hsin-Chu (TW); Jen-Chieh Chen, Hsin-Chu (TW); Kai-Yuan Siao, Hsin-Chu (TW); Yi-Fan Lin, Hsin-Chu (TW)

(73) Assignee: AU Optronics Corp, Hsin-Chu (TW)

(21) Appl. No.: 14/052,762

(22) Filed: Oct. 13, 2013

(30) Foreign Application Priority Data
Mar. 15, 2013 (TW) 102109313

(51) Int. Cl. G09G 3/36

(52) U.S. Cl. CPC G09G 3/3611
USPC 345/212; 345/87

(57) ABSTRACT

A plurality of pixels of a display panel are driven with a first polarity inversion to display a first image, driven with the first polarity inversion to display a second image after the first image is displayed, driven with a second polarity inversion to display a third image, and driven with the second polarity inversion to display a fourth image after the third image is displayed. The polarity of a first pixel of the first image is opposite to the polarity of a first pixel of the second image. The polarity of a first pixel of the third image is opposite to the polarity of a first pixel of the fourth image. The first polarity inversion is different from the second polarity inversion.

### BACKGROUND OF THE INVENTION

1. Field of the Invention

The present invention is related to a display panel and a method of displaying images, and more particularly to a method capable of improving image quality and reducing energy consumption of a display panel.

2. Description of the Prior Art

Liquid crystal displays (LCDs) and light emitting diode (LED) displays are two kinds of the most popular displays nowadays. Due to the properties of lightweight, low energy consumption, and free of radiation emission, such kinds of displays have gradually replaced the cathode ray tube (CRT) monitors of conventional personal computers and have been widely-used in many portable information products, such as notebooks, personal digital assistants (PDAs), etc.

Portable electronic apparatuses, e.g. smart phones, notebooks and tablet computers, have a trend to integrate multiple functions and to improve video and audio performance. However, since the functions and performance thereof are enhanced continually, the energy consumption of the portable electronic apparatus has increased vastly. Moreover, since the portable electronic apparatus may be only powered by the built-in battery thereof when the user operates the portable electronic apparatus outdoor, the electric quantity of the battery may be vastly consumed, such that it would be inconvenient to the user.

Therefore, it is an important issue to reduce the energy consumption of the display panel of the electronic apparatus while designing the electronic apparatus. The conventional alternating current driven methods of a liquid crystal display include column inversion, dot inversion, etc. In general, the display driven with dot inversion has better image quality and greater energy consumption. For the sake of reducing energy consumption, four line inversion is a usual method for driving the display, but it would result in an serious grid effect while displaying images, such that the image quality would be reduced.

### SUMMARY OF THE INVENTION

An embodiment of the present invention provides a display panel comprising a plurality of pixels, a plurality of data lines, and a data driver. The data lines are coupled to the pixels, and the data driver is coupled to the data lines and configured for driving the pixels to display a first image with a first polarity inversion; driving the pixels to display a second image with the first polarity inversion after the pixels display the first image, wherein a polarity of a first pixel of the first image is opposite to a polarity of a first pixel of the second image; driving the pixels to display a third image with a second polarity inversion; and driving the pixels to display a fourth image with the second polarity inversion after the pixels display the third image, wherein a polarity of a first pixel of the third image is opposite to a polarity of a first pixel of the fourth image, and the first polarity inversion is different from the second polarity inversion.

An embodiment of the present invention provides a method for displaying images by a display panel. The method comprises driving a plurality of pixels of the display panel to display a first image with a first polarity inversion; driving the pixels to display a second image with a second polarity inversion after the pixels display the first image; driving the pixels to display a third image with a third polarity inversion after the pixels display the second image; driving the pixels to display a fourth image with a fourth polarity inversion after the pixels display the third image; driving the pixels to display a fifth image with a fifth polarity inversion after the pixels display the fourth image; and driving the pixels to display a sixth image with a sixth polarity inversion after the pixels display the fifth image. A polarity of a first pixel of the fourth image is opposite to a polarity of a first pixel of the first image. A polarity of a first pixel of the fourth image is opposite to a polarity of a first pixel of the second image. A sum of polarities of the pixels while displaying the first image, the second image, the third image, the fourth image, the fifth image and the sixth image is equal to zero, and the first polarity inversion is different from the second polarity inversion.

According to the embodiments of the present invention, when the display panel displays images, the grid effect of the images would be reduced, the image quality thereof is improved accordingly, and the energy consumption of the display would be far less then that of a display merely driven with dot inversion, such that it would be energy saving.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a flowchart illustrating a method for displaying images by a display panel according to a first embodiment of the present invention.

FIG. 2 to FIG. 4 are schematic diagrams respectively illustrating variations of polarities of pixels of the display panel according to the first embodiment of the present invention.

FIG. 5 is a flowchart illustrating a method for displaying images by a display panel according to a second embodiment of the present invention.

FIG. 6 is a flowchart illustrating a method for displaying images by a display panel according to a third embodiment of the present invention.

FIG. 7 is a schematic diagram illustrating variations of polarities of pixels of a display panel according to the third embodiment of the present invention.

FIG. 8 is a schematic diagram illustrating summing polarities of the pixels of the images shown in FIG. 7.

FIG. 9 is a schematic diagram of a display panel according to a fourth embodiment of the present invention.

FIG. 10 is a flowchart illustrating a method for displaying images by a display panel according to a fifth embodiment of the present invention.

### DETAILED DESCRIPTION

The detailed descriptions of the present invention are exemplified below in examples. However, the examples are merely used to illustrate the present invention, not to limit the present invention. Because one skilled in the art may modify the present invention or combine the present invention with some features within the scope of the present invention, the claimed scope of the present invention should be referred to in the following claims.

In the entire specification and claims, unless the contents clearly specify the meaning of some terms, the terms “a” or “the” may refer to one or at least one of elements or components. Besides, in the present disclosure, unless it can be clearly seen from the relating context that the examples or embodiments do not refer to multiple elements or components, singular articles may refer to one or at least one of elements or components. The meanings of every term used in the present claims and specification refer to a usual meaning known to one skilled in the art unless the meaning is additionally annotated. Some terms used to describe the present invention will be discussed to guide practitioners about the present invention. Every example in the present specification can not limit the claimed scope of the present invention.

The terms “substantially,” “around,” “about” and “approximately” can refer to within 20% of a given value or range, and preferably within 10%. Besides, the quantities provided herein can be approximate ones and can be described with the aforementioned terms if are without being specified. When a quantity, density, or other parameters includes a specified range, preferable range or listed ideal values, their values can be viewed as any number within the given range. For example, if it is described that the length of a component is X cm to Y cm, then it is equivalent to sentence “the length of the component is H, and H can be any real number value between the values of X and Y.”

Further, in the present specification and claims, the term “comprising” is open type and should not be viewed as the term “consisted of.” Besides, the term “electrically coupled” can be referring to either directly connecting or indirectly connecting between elements. Thus, if it is described in the below contents of the present invention that a first device is electrically coupled to a second device, the first device can be directly connected to the second device, or indirectly connected to the second device through other devices or means. Moreover, when the transmissions or generations of electrical signals are mentioned, one skilled in the art should understand some degradations or undesirable transformations could be generated during the operations. If it is not specified in the specification, an electrical signal at the transmitting end should be viewed as substantially the same signal as that at the receiving end. For example, when the end A of an electrical circuit provides an electrical signal S to the end B of the electrical circuit, the voltage of the electrical signal S may drop due to passing through the source and drain of a transistor or due to some parasitic capacitance. However, the transistor is not deliberately used to generate the effect of degrading the signal to achieve some result, that is, the signal S at the end A should be viewed as substantially the same as that at the end B.

Furthermore, it can be understood that the terms “comprising,” “including,” “having,” “containing,” and “involving” are open-ended terms, which refer to “may include but is not limited to so.” Besides, each of the embodiments or claims of the present invention is not necessary to achieve all the effects and advantages possibly to be generated, and the abstract and title of the present invention is used to assist for patent search and is not used to further limit the claimed scope of the present invention.

The embodiments and figures are provided as follows in order to illustrate the present invention in detail, but please notice that the claimed scope of the present invention is not limited by the provided embodiments and figures.

Please refer to FIG. 1 with reference of FIG. 2 to FIG. 4. FIG. 1 is a flowchart illustrating a method for displaying images by a display panel according to a first embodiment of the present invention. FIG. 2 to FIG. 4 are schematic diagrams respectively illustrating variations of polarities of pixels of the display panel according to the first embodiment of the present invention. The method according to the first embodiment of the present invention comprises:

Step 102: driving the pixels of the display panel to display a first image N1 with a first polarity inversion;

Step 104: driving the pixels to display a second image N2 with the first polarity inversion after the pixels display the first image;

Step 106: driving the pixels to display a third image N3 with a second polarity inversion;

Step 108: driving the pixels to display a fourth image N4 with the second polarity inversion after the pixels display the third image; and

Step 110: repeating steps 102 to 108.

Considering the sequence of the foresaid steps, step 104 and step 106 could be switched, and steps 102 and 104 could be switched with steps 106 and 108. In other words, multiple polarity inversions are used in each loop of executing steps 102 to 108, and for each loop, it is not necessary to accomplish all of the steps for driving the pixels with one of the polarity inversions before performing a step for driving the pixels with another polarity inversion. The various polarity inversions of the invention could be executed interlacedly or alternately. In steps 102 to 110, a polarity of a first pixel (e.g. a pixel in the first row and the first column) of the first image N1 is opposite to a polarity of a first pixel of the second image N2, a polarity of a first pixel of the third image N3 is opposite to a polarity of a first pixel of the fourth image N4, and the first polarity inversion is different from the second polarity inversion.

In step 102, the first polarity inversion may be one dot inversion or two dot inversion. One dot inversion indicates that every pixel in every single row and single column has a polarity different from that of the pixels neighboring to the pixel. Two dot inversion indicates that every two pixels in one row and two columns have a polarity which is different from that of two neighboring pixels, or that every two pixels in two rows and one column have a polarity which is different from that of two neighboring pixels. The polarity inversion executed in step 104 is identical with that executed in step 102, but the processes of polarities of the pixels are inversed. For example, the polarities of the first image N1 are inversed into the polarities of the second image N2. In other words, in steps 102 to 110, the polarity of the first pixel of the first image N1 is positive, the polarity of the first pixel of the second image N2 is negative, the polarity of the first pixel of the third image N3 is positive, and the polarity of the first pixel of the fourth image N4 is negative. In step 106, the second polarity inversion may be four line inversion, eight line inversion, or column inversion. The polarity of pixels in each column is different from that of pixels in a neighboring column. Similarly, the inversion executed in step 108 is identical with that executed in step 106, but the processes of polarities are inversed.

As shown in FIG. 2, the first polarity inversion for the first image N1 and the second image N2 is dot inversion, and the second polarity inversion for the third image N3 and the fourth image N4 is four line inversion. The polarities of the pixels of the display panel are represented by a positive sign “+” and a negative sign “−”. The positive sign “+” indicates pixels with a positive polarity, and the negative sign “−” indicates pixels with a negative polarity. The second image N2 is an image next to the first image N1, the third image N3 is an image next to the second image N2, and so on. With dot inversion, each pixel has a polarity opposite to that of neighboring pixels, and each pixel has opposite polarities in the first image N1 and the second image N2. With four line inversion, every four pixels in two rows and two columns have a polarity opposite to that of four neighboring pixels, and the four pixels have opposite polarities in the third image N3 and the fourth image N4. Eight line inversion is similar with two dot inversion and four line inversion and indicates that every eight pixels in two rows and four columns have a polarity opposite to that of eight neighboring pixels, or that every eight pixels in four rows and two columns have a polarity opposite to that of eight neighboring pixels. According to the embodiment in FIG. 2, the grid effect caused by the second polarity inversion (i.e. four line inversion) would be neutralized by the first polarity inversion (i.e. dot inversion). Therefore, the display panel displays images without the grid effect. Moreover, the energy consumption of the display panel would be far less then that of a display merely driven with dot inversion. Hence, the display panel is energy saving.

As shown in FIG. 3, the first polarity inversion for the first image N1 and the second image N2 is two dot inversion, and the second polarity inversion for the third image N3 and the fourth image N4 is four line inversion. The instructions of two dot inversion and four line inversion could be found in the above description. For example, two dot inversion may indicate that every two pixels in a same row have a polarity opposite to that of two neighboring pixels, and the each pixel has opposite polarities in the first image N1 and the second image N2. However, two dot inversion may indicate that every two pixels in a same column have a polarity opposite to that of two neighboring pixels.

As shown in FIG. 4, the first polarity inversion for the first image N1 and the second image N2 is dot inversion, and the second polarity inversion for the third image N3 and the fourth image N4 is eight line inversion.

Similarly, according to the embodiment of FIG. 3 and FIG. 4, the grid effect caused by the second polarity inversion (i.e. four line inversion or eight line inversion) would be neutralized by the first polarity inversion (i.e. two dot inversion or dot inversion). Therefore, the display panel displays images without the grid effect. Moreover, the energy consumption of the display panel would be far less then that of a display merely driven with dot inversion or two dot inversion. Hence, the display panel is energy saving.

Please refer to FIG. 5. FIG. 5 is a flowchart illustrating a method for displaying images by a display panel according to a second embodiment of the present invention. The method according to the second embodiment of the present invention comprises:

Step 502: driving the pixels of the display panel to display a first image with a first polarity inversion;

Step 504: driving the pixels to display a second image with the first polarity inversion after the pixels display the first image;

Step 506: driving the pixels to display a third image with a second polarity inversion;

Step 508: driving the pixels to display a fourth image with the second polarity inversion after the pixels display the third image;

Step 510: driving the pixels to display a fifth image with a third polarity inversion;

Step 512: driving the pixels to display a sixth image with the third polarity inversion after the pixels display the fifth image;

Step 514: repeating steps 502 to 512.

The sequence of steps 502 to 512 is not limited to the sequence listed above. For example, steps 504 and 508 could be executed after step 510 or 512. In steps 502 to 514, the polarity of the first pixel of the first image is opposite to the polarity of the first pixel of the second image, the polarity of the first pixel of the third image is opposite to the polarity of the first pixel of the fourth image, the polarity of the first pixel of the fifth image is opposite to the polarity of the first pixel of the sixth image, and the first polarity inversion, the second polarity inversion and the third polarity inversion are different from each other. In addition, the polarity of the first pixel of the first image is positive, the polarity of the first pixel of the second image is negative, the polarity of the first pixel of the third image is positive, the polarity of the first pixel of the fourth image is negative, the polarity of the first pixel of the fifth image is positive, and the polarity of the first pixel of the sixth image is negative.

The first polarity inversion may be one dot inversion or two dot inversion, the second polarity inversion may be column inversion or four line inversion, and the third polarity inversion may be frame inversion, row inversion, column inversion or dot inversion, etc. In brief, the first polarity inversion, the second polarity inversion and the third polarity inversion are different from each other, and the categories of the first to third polarity inversions according to the present invention is not limited thereto.

Please refer to FIG. 6 and FIG. 7. FIG. 6 is a flowchart illustrating a method for displaying images by the display panel according to a third embodiment of the present invention. FIG. 7 is a schematic diagram illustrating variations of polarities of pixels of a display panel according to the third embodiment of the present invention. The method according to the third embodiment of the present invention comprises:

Step 602: driving the pixels of the display panel to display a first image N1 with two column inversion;

Step 604: driving the pixels to display a second image N2 with four line inversion;

Step 606: driving the pixels to display a third image N3 with four line inversion;

Step 608: driving the pixels to display a fourth image N4 with two dot inversion;

Step 610: driving the pixels to display a fifth image N5 with two dot inversion;

Step 612: driving the pixels to display a sixth image N6 with two column inversion;

Step 614: repeating steps 602 to 612.

Please refer to FIG. 7 again. The first image N1 and the sixth image N6 are displayed with two column inversion, and the polarity of any pixel of the first image N1 is opposite to that of the pixel at the same location in the sixth image N6. For example, the polarities of the pixels in the first column and the second column of the first image N1 are all either positive or negative. If the polarities of the pixels in the first column and the second column of the first image N1 are all positive, the polarities of the pixels in the first column and the second column of the sixth image N6 are all negative. If the polarities of the pixels in the first column and the second column of the first image N1 are all negative, the polarities of the pixels in the first column and the second column of the sixth image N6 are all positive. The second image N2 and the third image N3 are displayed with four line inversion, and the polarity of any pixel of the second image N2 is opposite to that of the pixel at the same location in the third image N3. For example, the polarities of the pixels in the first column, first column to the second column, second row of the second image N2 are all either positive or negative. If the polarities of the pixels in the first column, first column to the second column, second row of the second image N2 are all positive, the polarities of the pixels in the first column, first column to the second column, second row of the third image N3 are all negative. If the polarities of the pixels in the first column, first column to the second column, second row of the second image N2 are all negative, the polarities of the pixels in the first column, first column to the second column, second row of the third image N3 are all positive. The fourth image N4 and the fifth image N5 are displayed with two dot inversion, and the polarity of any pixel of the fourth image N4 is opposite to that of the pixel at the same location in the fifth image N5. For example, the polarities of two pixels in the first row of the fourth image N4 are either positive or negative. If the polarities of the two pixels in the first row of the fourth image N4 are positive, the polarities of the two corresponded pixels in the first row of the fifth image N5 are negative. If the polarities of the two pixels in the first row of the fourth image N4 are negative, the polarities of the two corresponded pixels in the first row of the fifth image N5 are positive. The polarities of the pixels located on other positions would be known as shown in FIG. 7 and would not described in detail accordingly.

Please refer to FIG. 8. FIG. 8 is a schematic diagram illustrating summing polarities of the pixels of the images shown in FIG. 7. As shown in FIG. 8, SUM1 is a result by summing the polarities of the first image N1, the second image N2 and the third image N3, SUM2 is a result by summing the polarities of the fourth image N4, the fifth image N5 and the sixth image N6, and SUM1 and SUM2 are complementary with respect to polarities. In other words, a sum of polarities of the pixels while displaying the first image N1, the second image N2, the third image N3, the fourth image N4, the fifth image N5 and the sixth image N6 is equal to zero. The present invention is not limited to use three inversions only. Numerous modifications and alterations of a display panel and method for displaying images according to the present invention may drive the pixels within a display period with various polarity inversions which are used in a sequential order or in an interlaced order, where the sum of the polarities of a preceding half of the displayed images is complementary with the sum of the polarities of a posterior half of the displayed images, or the sum of the polarities of the all displayed images within the display period is equal to zero.

Similarly, in the second embodiment and the third embodiment, the grid effect caused by the second polarity inversion and the third polarity inversion would be neutralized by the first polarity inversion. Therefore, the display panel displays images without the grid effect. Moreover, the energy consumption of the display panel would be far less then that of a display merely driven with one dot inversion or two dot inversion, such that it is energy saving.

Please refer to FIG. 9. FIG. 9 is a schematic diagram of a display panel 900 according to a fourth embodiment of the present invention. The display panel 900 comprises a plurality of pixels 910, a plurality of data lines 920 and a data driver 930. The data lines 920 are coupled to the pixels 910, and the data driver 930 is coupled to the data lines 920 and provides a plurality of polarity signals to the pixels 910 to drive the pixels 910 to display the first image N1 with the first polarity inversion, to drive the pixels 910 to display the second image N2 with the first polarity inversion after the first image N1 is displayed, to drive the pixels 910 to display the third image N3 with the second polarity inversion, and to drive the pixels 910 to display the fourth image N4 with the second polarity inversion after the third image N3 is displayed. The polarity of the first pixel of the first image N1 is opposite to the polarity of the first pixel of the second image N2, the polarity of the first pixel of the third image N3 is opposite to the polarity of the first pixel of the fourth image N4, and the first polarity inversion is different from the second polarity inversion. The first polarity inversion may be one dot inversion or two dot inversion. The second polarity inversion is four line inversion, eight line inversion or column inversion.

For example, the polarity of the first pixel of the first image N1 is positive, the polarity of the first pixel of the second image N2 is negative, the polarity of the first pixel of the third image N3 is positive, and the polarity of the first pixel of the fourth image N4 is negative. However, the present invention is not limited thereto. The data driver 930 may be configured to use a scheme of a half source driver or a scheme of a one gate one data (1G1D) source driver.

The foresaid display panel 900 is driven based on the steps of the first embodiment of the present invention. However, the display panel 900 may be configured to be driven based on steps of other embodiments. For example, the display panel 900 may be driven based on steps of the third embodiment of the present invention. The data driver 930 may further provide other polarity signals to the pixels 910 to drive the pixels 910 to display the fifth image N5 with the third polarity inversion, and to drive the pixels 910 to display the sixth image N6 with the third polarity inversion after the fifth image N5 is displayed. The polarity of the first pixel of the fifth image N5 is opposite to the polarity of the first pixel of the sixth image N6, and the first polarity inversion, the second polarity inversion and the third polarity inversion are different. In addition, the sequence of displaying the first, second, third, fourth, fifth and sixth images N1 to N6 is the third image N3, the fifth image N5, the sixth image N6, the first image N1, the second image N2 and the fourth image N4. The second polarity inversion may be column inversion, and the third polarity inversion may be four line inversion. For example, the polarity of the first pixel (i.e. the pixel in the first row and the first column) of the first image N1 is positive, the polarity of the first pixel of the second image N2 is negative, the polarity of the first pixel of the third image N3 is positive, the polarity of the first pixel of the fourth image N4 is negative, the polarity of the first pixel of the fifth image N5 is positive, and the polarity of the first pixel of the sixth image N6 is negative. However, the present invention is not limited thereto.

Please refer to FIG. 10. FIG. 10 is a flowchart illustrating a method for displaying images by a display panel according to a fifth embodiment of the present invention. The method according to the fifth embodiment of the present invention comprises:

Step 1002: driving the pixels of the display panel to display a first image with a first polarity inversion;

Step 1004: driving the pixels to display a second image with a second polarity inversion after the pixels display the first image;

Step 1006: driving the pixels to display a third image with a third polarity inversion after the pixels display the second image;

Step 1008: driving the pixels to display a fourth image with a fourth polarity inversion after the pixels display the third image, wherein the polarity of the first pixel of the fourth image is opposite to the polarity of the first pixel of the first image;

Step 1010: driving the pixels to display a fifth image with a fifth polarity inversion after the pixels display the fourth image, wherein the polarity of the first pixel of the fifth image is opposite to the polarity of the first pixel of the second image;

Step 1012: driving the pixels to display a sixth image with a sixth polarity inversion after the pixels display the fifth image, wherein a sum of polarities of the pixels while displaying the first image, the second image, the third image, the fourth image, the fifth image and the sixth image is equal to zero, and the first polarity inversion is different from the second polarity inversion;

Step 1014: repeating steps 1002 to 1012.

In steps 1002 to 1014, the first polarity inversion may be one dot inversion or two dot inversion, and the second polarity inversion may be four line inversion, eight line inversion or column inversion.

The third polarity inversion may be same as the first polarity inversion, the polarity of the first pixel of the third image may be opposite to the polarity of the first pixel of the first image, the fourth polarity inversion may be same as the second polarity inversion, and the polarity of the first pixel of the fourth image may be opposite to the polarity of the first pixel of the second image.

Moreover, the third polarity inversion may be different from the first polarity inversion and the second polarity inversion, the fourth polarity inversion may be same as the first polarity inversion, the fifth polarity inversion may be same as the second polarity inversion, and the sixth polarity inversion may be same as the third polarity inversion.

The polarity of the first pixel of the fourth image may be opposite to the polarity of the first pixel of the first image, the polarity of the first pixel of the fifth image may be opposite to the polarity of the first pixel of the second image, and the polarity of the first pixel of the sixth image may be opposite to the polarity of the first pixel of the third image.

The fourth embodiment and the fifth embodiment are similar to the first to third embodiments and are capable of displaying images without the grid effect and reducing energy consumption.

In summary, according to the first to fifth embodiments of the present invention, the display panel displays images without the grid effect, and the energy consumption of the display panel would be far less then that of a display merely driven with dot inversion or two dot inversion. Accordingly, the display panel according to the present invention is energy saving.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A display panel, comprising:
a plurality of pixels;
a plurality of data lines, coupled to the pixels; and
a data driver, coupled to the data lines and configured for:
driving the pixels to display a first image with a first polarity inversion;
driving the pixels to display a second image with the first polarity inversion after the pixels display the first image, wherein a polarity of a first pixel of the first image is opposite to a polarity of a first pixel of the second image;
driving the pixels to display a third image with a second polarity inversion; and
driving the pixels to display a fourth image with the second polarity inversion after the pixels display the third image, wherein a polarity of a first pixel of the third image is opposite to a polarity of a first pixel of the fourth image, and the first polarity inversion is different from the second polarity inversion.

2. The display panel of claim 1, wherein the first polarity inversion is one dot inversion or two dot inversion, and the second polarity inversion is four line inversion, eight line inversion or column inversion.

3. The display panel of claim 2, wherein the polarity of the first pixel of the first image is positive, the polarity of the first pixel of the second image is negative, the polarity of the first pixel of the third image is positive, and the polarity of the first pixel of the fourth image is negative.

4. The display panel of claim 2, wherein the data driver is further configured for:
driving the pixels to display a fifth image with a third polarity inversion; and
driving the pixels to display a sixth image with the third polarity inversion after the pixels display the fifth image;
wherein a polarity of a first pixel of the fifth image is opposite to a polarity of a first pixel of the sixth image, and the first polarity inversion and the second polarity inversion are different from the third polarity inversion.

5. The display panel of claim 4, wherein a sequence of displaying the first, second, third, fourth, fifth and sixth images is the third image, the fifth image, the sixth image, the first image, the second image and the fourth image.

6. The display panel of claim 4, wherein the polarity of the first pixel of the first image is positive, the polarity of the first pixel of the second image is negative, the polarity of the first pixel of the third image is positive, the polarity of the first pixel of the fourth image is negative, the polarity of the first pixel of the fifth image is positive, and the polarity of the first pixel of the sixth image is negative.

7. The display panel of claim 1, wherein the polarity of the first pixel of the first image is positive, the polarity of the first pixel of the second image is negative, the polarity of the first pixel of the third image is positive, and the polarity of the first pixel of the fourth image is negative.

8. The display panel of claim 1, wherein the data driver is further configured for:
driving the pixels to display a fifth image with a third polarity inversion; and
driving the pixels to display a sixth image with the third polarity inversion after the pixels display the fifth image;
wherein a polarity of a first pixel of the fifth image is opposite to a polarity of a first pixel of the sixth image, and the first polarity inversion and the second polarity inversion are different from the third polarity inversion.

9. The display panel of claim 8, wherein a sequence of displaying the first, second, third, fourth, fifth and sixth images is the third image, the fifth image, the sixth image, the first image, the second image and the fourth image.

10. The display panel of claim 8, wherein the polarity of the first pixel of the first image is positive, the polarity of the first pixel of the second image is negative, the polarity of the first pixel of the third image is positive, the polarity of the first pixel of the fourth image is negative, the polarity of the first pixel of the fifth image is positive, and the polarity of the first pixel of the sixth image is negative.

11. A method for displaying images by a display panel, comprising:
driving a plurality of pixels of the display panel to display a first image with a first polarity inversion;
driving the pixels to display a second image with a second polarity inversion after the pixels display the first image;
driving the pixels to display a third image with a third polarity inversion after the pixels display the second image;
driving the pixels to display a fourth image with a fourth polarity inversion after the pixels display the third image, wherein a polarity of a first pixel of the fourth image is opposite to a polarity of a first pixel of the first image;
driving the pixels to display a fifth image with a fifth polarity inversion after the pixels display the fourth image, wherein a polarity of a first pixel of the fifth image is opposite to a polarity of a first pixel of the second image; and
driving the pixels to display a sixth image with a sixth polarity inversion after the pixels display the fifth image, wherein a sum of polarities of the pixels while displaying the first image, the second image, the third image, the fourth image, the fifth image and the sixth image is equal to zero, and the first polarity inversion is different from the second polarity inversion.

12. The method of claim 11, wherein the first polarity inversion is one dot inversion or two dot inversion, and the second polarity inversion is four line inversion, eight line inversion or column inversion.

13. The method of claim 12, wherein the third polarity inversion, the first polarity inversion and the second polarity inversion are different, the fourth polarity inversion is same as the first polarity inversion, the fifth polarity inversion is same as the second polarity inversion, and the sixth polarity inversion is same as the third polarity inversion.

14. The method of claim 11, wherein the polarity of a first pixel of the sixth image is opposite to the polarity of a first pixel of the third image.
